(19) United States
(12) Patent Application Publication
(10) Pub. No.: US 2005/0257890 A1
(43) Pub. Date: Nov. 24, 2005

(54) Method of cleaning an interior of a remote plasma generating tube and appartus and method for processing a substrate using the same

(76) Inventors: Jae-Young Park, Yongin-si (KR); Seung-Jin Lee, Suwon-si (KR); Young-Min Kim, Yongin-si (KR)

Correspondence Address: LEE, STERBA & MORSE, P.C., Suite 2000, 1101 Wilson Boulevard, Arlington, VA, 22209, US

(21) Appl. No.: 11/080,521

(22) Filed: Mar. 16, 2005

(30) Foreign Application Priority Data
May 21, 2004 (KR) 2004-36416

(51) Int. Cl. B44C 1/22

(52) U.S. Cl. 156/345.35; 216/67; 134/1.1

(57) ABSTRACT

A method of cleaning a remote plasma generating tube, and an apparatus and method for processing a substrate using the same, includes providing a cleaning gas into the remote plasma generating tube for generating a remote plasma, the remote plasma generating tube being connected to a processing chamber for processing a substrate using the remote plasma, forming a cleaning plasma from the cleaning gas, and removing particles formed inside the remote plasma generating tube using the cleaning plasma.

### BACKGROUND OF THE INVENTION

1. Field of the Invention

The present invention relates to an apparatus and a method for processing a semiconductor substrate. More particularly, the present invention relates to a method of cleaning an interior of a remote plasma generating tube, and a method and an apparatus for processing a semiconductor substrate using the same.

2. Description of the Related Art

Generally, semiconductor devices are manufactured by performing a fabrication process in which electrical circuits are formed on a silicon wafer, and an electrical die sorting (EDS) process in which the electrical characteristics of the electrical circuits formed by the fabrication process are inspected. Additionally, the semiconductor devices are independently encapsulated using an epoxy resin in a packaging process.

A semiconductor device, such as a DRAM of 256 mega bits or an SRAM of giga bits, typically has a multi-layered structure. In a conventional semiconductor device, a plurality of layers is sequentially stacked on a semiconductor substrate to form the multi-layered structure on the semiconductor substrate. During the formation of these layers, the semiconductor substrate may be frequently exposed to an atmosphere including oxygen (O₂) gas. When the semiconductor substrate is exposed to oxygen gas, silicon contained in the semiconductor substrate may be reacted with the oxygen gas, which forms a native oxide film on the semiconductor substrate.

FIG. 1 illustrates a cross-sectional view of a native oxide film formed on a semiconductor substrate, as conventionally occurs.

When a semiconductor substrate 10 including silicon contacts oxygen gas, a native oxide film 12 is formed on the semiconductor substrate 10 due to a reaction between oxygen and silicon. The native oxide film 12 may generally have a thickness of several angstroms (A) on the surface of the semiconductor substrate 10. The native oxide film 12 may cause a failure of a semiconductor device having the multi-layered structure. In addition, the native oxide film 12 may increase the contact resistance of the semiconductor device so that the semiconductor device may have poor reliability and response speed.

FIG. 2 illustrates a cross-sectional view of a native oxide film formed on a semiconductor substrate on which a contact hole is positioned, as conventionally occurs.

Referring to FIG. 2, after an insulation layer 24 is formed on a semiconductor substrate 20, the insulation layer 24 is partially etched to form a contact hole 26 exposing a portion of the semiconductor substrate 20 that may correspond to a contact region.

A native oxide film 22 is formed at the exposed portion of the semiconductor substrate 20 due to a reaction between silicon in the semiconductor substrate 20 and oxygen gas in the atmosphere. When the native oxide film 22 forms on the contact region, the contact resistance of the semiconductor device may increase after a contact plug or pad (not shown) is formed to fill the contact hole 26. Therefore, the native oxide film 22 requires removal from the semiconductor substrate 20. Such native oxide film 22 may be removed using one of several conventional methods.

According to one conventional method, a native oxide film is removed from a substrate by a wet etching process. However, the native oxide film may not be easily removed by the wet etching process when the native oxide film is positioned in a contact hole having a high aspect ratio. Further, a chemical used in the wet etching process may damage other layers or wirings formed on the substrate.

In other conventional methods, a native oxide film is removed from a substrate by a dry etching process. More specifically, the native oxide film is etched using an etching gas so that the native oxide film may be easily removed when the native oxide film is formed in a contact hole having a high aspect ratio. In addition, the etching gas may cause less damage to layers formed on the substrate as compared to the chemical used in the wet etching process.

The etching gas may include a NHₓF_{y} gas that may be formed by reacting a hydrogen radical with nitrogen trifluoride (NF₃) gas. The hydrogen radical may be generated in a remote plasma generator connected to a processing chamber and may be formed using a reaction gas including hydrogen (H₂) or ammonia (NH₃).

The remote plasma generator includes a remote plasma generating tube, to which the reaction gas is provided, and an energy source for providing energy to excite the reaction gas into a plasma phase. The energy source may include a microwave power source for providing microwave energy having a frequency of about 2.45 GHz. The reaction gas in the remote plasma generating tube is excited to the plasma phase by the microwave energy transferred from the energy source.

The excited remote plasma, however, may cause particles to attach to an interior of the remote plasma generating tube. Further, the particles may become detached from the remote plasma generating tube. When the particles become detached and are introduced into the processing chamber, semiconductor substrates in the processing chamber may be contaminated by the particles. As a result, semiconductor devices may perform poorly and exhibit poor reliability due to the particles. Therefore, a method of cleaning the interior of the remote plasma generating tube to remove the particles from the remote plasma generating tube is required.

### SUMMARY OF THE INVENTION

The present invention is therefore directed to a method of cleaning an interior of a remote plasma generating tube, and a method and an apparatus for processing a semiconductor substrate using the same, which substantially overcome one or more of the problems due to the limitations and disadvantages of the related art.

It is a feature of an embodiment of the present invention to provide a method of cleaning a remote plasma generating tube to remove various particles from an interior of the remote plasma generating tube using cleaning plasma, thereby preventing contamination of semiconductor substrates being processed.

It is another feature of an embodiment of the present invention to provide a method of processing a substrate using a remote plasma generating tube that reduces contamination without reducing throughput of the process.

It is still another feature of an embodiment of the present invention to provide an apparatus for processing a substrate using a remote plasma generating tube that is able to prevent contamination of a substrate being processed therein.

At least one of the above and other features and advantages of the present invention may be realized by providing a method of cleaning a remote plasma generating tube including providing a cleaning gas into the remote plasma generating tube for generating a remote plasma, the remote plasma generating tube being connected to a processing chamber for processing a substrate using the remote plasma, forming a cleaning plasma from the cleaning gas, and removing particles formed inside the remote plasma generating tube using the cleaning plasma.

Forming the cleaning plasma may include using microwave energy.

The cleaning gas may include an inactive gas. The cleaning gas may include any one selected from the group including nitrogen (N₂) gas and argon (Ar) gas.

The remote plasma generating tube may include quartz (SiO₂). The particles may include reaction by-products generated by a reaction between the quartz and a reaction gas for processing the substrate. The reaction gas may include any one selected from the group including hydrogen (H₂) and ammonia (NH₃).

At least one of the above and other features and advantages of the present invention may be realized by providing a method of processing a substrate using a remote plasma generating tube, including forming a remote plasma from a first reaction gas using the remote plasma generating tube connected to a processing chamber for processing a substrate in the processing chamber, introducing the remote plasma into the processing chamber to process the substrate, providing a cleaning gas into the remote plasma generating tube, forming a cleaning plasma from the cleaning gas, and removing particles formed inside the remote plasma generating tube using the cleaning plasma.

The first reaction gas may include any one selected from the group including hydrogen and ammonia. The remote plasma generating tube may include quartz. The particles may include reaction by-products generated by a reaction between the first reaction gas and the quartz. The particles may include silicon oxynitride (SiON).

The remote plasma may include a hydrogen radical. Introducing the remote plasma into the processing chamber to process the substrate may further include etching a layer formed on the substrate. The layer formed on the substrate may include a native oxide film. Etching the layer may further include providing a second reaction gas into the processing chamber to form an etching gas by a reaction between the hydrogen radical and the second reaction gas, reacting the etching gas with the native oxide film to form reaction by-products on the substrate, and removing the reaction by-products. Reacting the etching gas with the native oxide film may be performed at a temperature of about 15 to about 30° C.

Removing the reaction by-products may further include evaporating the reaction by-products by increasing a temperature around the substrate to a range of about 100 to about 200° C. and discharging the evaporated reaction by-products.

The second reaction gas may include nitrogen trifluoride (NF₃).

Introducing the remote plasma into the processing chamber may include processing a plurality of substrates.

Forming the remote plasma and forming the cleaning plasma may include using microwave energy.

The cleaning gas may include an inactive gas. Providing the cleaning gas may include providing the cleaning gas at a flow rate of about one (1) to about five (5) standard liters per minute (SLM).

Providing the cleaning gas, forming the cleaning plasma and removing the particles may be performed for about thirty (30) seconds to about five (5) minutes.

The method may further include loading the substrate to be processed into the processing chamber and unloading a processed substrate from the processing chamber. Providing the cleaning gas, forming the cleaning plasma and removing the particles may be performed while unloading the processed substrate from the processing chamber. Providing the cleaning gas, forming the cleaning plasma and removing the particles may be performed between unloading the processed substrate from the processing chamber and loading a substrate to be processed into the processing chamber.

Forming the remote plasma and introducing the remote plasma may be repeatedly performed after removing the particles.

In an embodiment of the present invention, providing the cleaning gas, forming the cleaning plasma, and removing the particles may be performed before forming the remote plasma and introducing the remote plasma, and the method may further include loading the substrate into the processing chamber, after removing the particles, and then forming the remote plasma by providing the first reaction gas into the remote plasma generating tube. Loading the substrate into the processing chamber may include loading a plurality of substrates into the processing chamber and the remote plasma is introduced into the processing chamber to process the plurality of the substrates. The method may further include unloading a processed substrate from the processing chamber, wherein providing the cleaning gas into the remote plasma generating tube, forming the cleaning plasma from the cleaning gas and removing the particles formed inside the remote plasma generating tube are performed while unloading the processed substrate from the processing chamber. Alternatively, the method may further include unloading a plurality of processed substrates from the processing chamber, wherein providing the cleaning gas into the remote plasma generating tube, forming the cleaning plasma from the cleaning gas and removing the particles formed inside the remote plasma generating tube are performed between unloading the processed substrates from the processing chamber and loading substrates to be processed into the processing chamber.

Forming the cleaning plasma and forming the remote plasma may include using microwave energy transferred through the remote plasma generating tube.

Loading the substrate into the processing chamber may include using a boat, in which the substrate is disposed, and moving the boat into the processing chamber.

In an embodiment of the present invention, before providing the cleaning gas into the remote plasma generating tube, the method may further include introducing a second reaction gas into the processing chamber while introducing the remote plasma, forming a third reaction gas by reacting the remote plasma with the second reaction gas, forming reaction by-products by reacting the third reaction gas with a layer formed on the substrate loaded in the processing chamber, evaporating the reaction by-products, and discharging the evaporated reaction by-products from the processing chamber. The layer may include a native oxide film. The remote plasma may include a hydrogen radical. The second reaction gas may include nitrogen trifluoride. Evaporating the reaction by-products may include evaporating the reaction by-products at a temperature of about 100 to about 200° C. The remote plasma generating tube may include quartz, and the first reaction gas may include any one selected from the group including hydrogen and ammonia. The cleaning gas may include any one selected from the group including nitrogen and argon.

At least one of the above and other features and advantages of the present invention may be realized by providing an apparatus for processing a substrate using a remote plasma generating tube including a processing chamber for receiving a substrate to be processed, a remote plasma generating tube connected to the processing chamber, an energy source for applying energy to the remote plasma generating tube to excite a gas provided into the remote plasma generating tube to a plasma phase, a reaction gas supply unit for supplying the remote plasma generating tube with a reaction gas to form a remote plasma for processing the substrate, and a cleaning gas supply unit for supplying the remote plasma generating tube with a cleaning gas to form a cleaning plasma for removing particles formed inside the remote plasma generating tube.

The energy source may include a microwave power source.

The apparatus may further include a second reaction gas supply unit for supplying a second reaction gas into the processing chamber. The apparatus may further include a dispersion plate having a plurality of slits to uniformly provide the reaction gas into the processing chamber.

The apparatus may further include a load lock chamber disposed adjacent to the processing chamber, wherein the load lock chamber temporarily stores a processed substrate and the substrate to be processed. The apparatus may further include a boat for receiving a plurality of substrates, wherein the boat is operable to move between the processing chamber and the load lock chamber.

The apparatus may further include a heater for heating the substrate. The apparatus may further include a chuck disposed in the processing chamber to support the substrate.

The apparatus may further include a vacuum unit connected to the processing chamber to discharge reaction by-products generated during the processing of the substrate and particles removed from the remote plasma generating tube.

According to the various embodiments of the present invention, particles generated on an interior of a remote plasma generating tube may be effectively removed using cleaning plasma. Therefore, contamination of semiconductor substrates may be prevented during an etching of predetermined layers formed on the semiconductor substrates. In addition, productivity of a process for manufacturing semiconductor devices may be improved. When a batch-type substrate processing apparatus is employed, the interior of the remote plasma generating tube may be cleaned between loading and unloading of the semiconductor substrates into or out of a processing chamber so that the semiconductor substrates may be more efficiently processed without decreasing throughput of the batch-type substrate processing apparatus.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a cross-sectional view of a native oxide film formed on a semiconductor substrate, as conventionally occurs;

FIG. 2 illustrates a cross-sectional view of a native oxide film formed on a semiconductor substrate on which a contact hole is positioned, as conventionally occurs;

FIG. 3 illustrates a cross-sectional view of an apparatus having a remote plasma generating tube for processing a substrate according to an embodiment of the present invention;

FIG. 4 illustrates a cross-sectional view of an apparatus having a remote plasma generating tube for processing a substrate according to another embodiment of the present invention;

FIG. 5 is a flowchart illustrating a method of processing a substrate using the apparatus equipped with the remote plasma generating tube in FIG. 3;

FIG. 6 is a graph showing a variance of particles on a semiconductor substrate relative to the number of batches when an ammonia gas is used;

FIG. 7 illustrates a plan view of particles distributed on a semiconductor substrate;

FIGS. 8 and 9 are scanning electron microscope (SEM) pictures illustrating particles on semiconductor substrates;

FIG. 10 is a graph showing a result of an auger electron spectroscopy analysis regarding particles on a semiconductor substrate; and

FIG. 11 is a graph showing amounts of particles after cleaning a remote plasma generating tube using cleaning plasma according to an embodiment of the present invention.

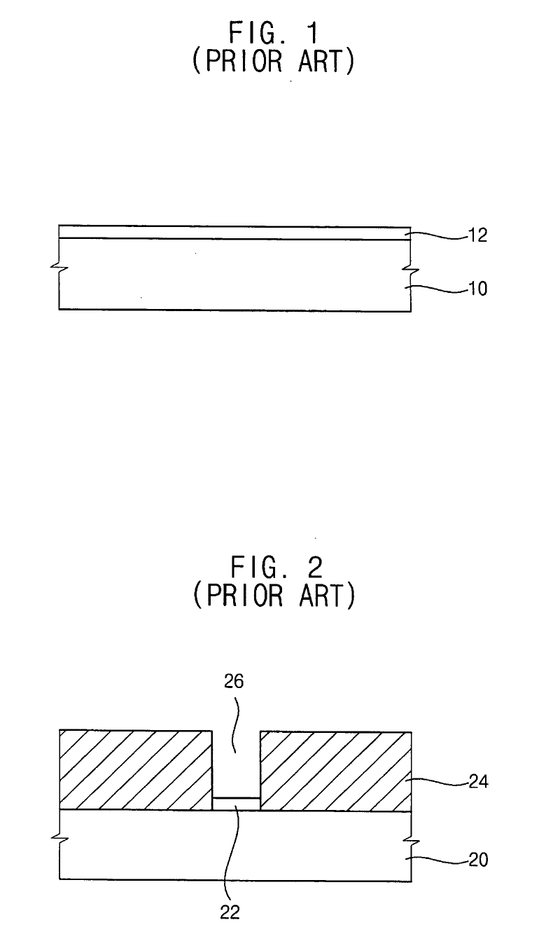

### DETAILED DESCRIPTION OF THE INVENTION

Korean Patent Application No. 2004-36416, filed on May 21, 2004, in the Korean Intellectual Property Office, and entitled: “Method of Cleaning a Surface of a Remote Plasma Generating Tube and Apparatus and Method for Processing a Substrate Using the Same,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

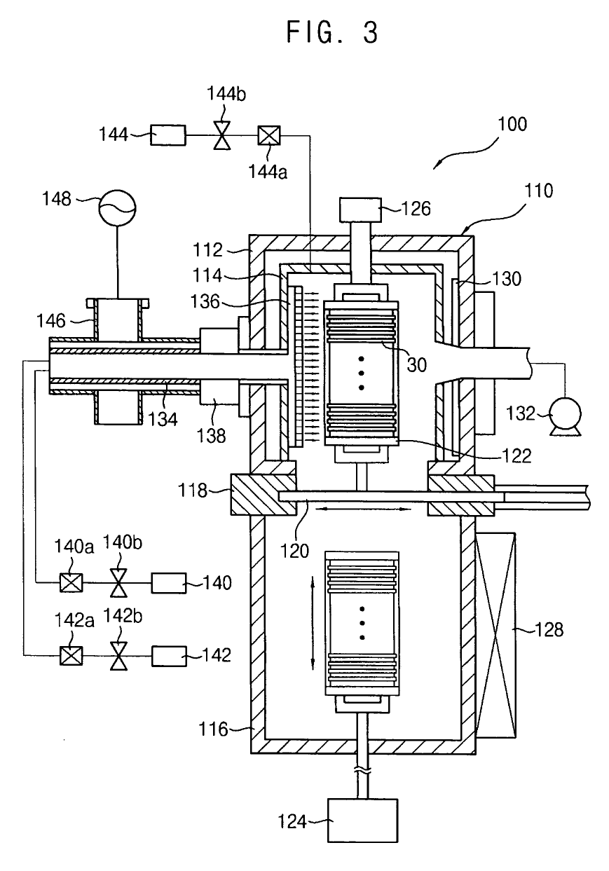

FIG. 3 illustrates a cross-sectional view of an apparatus having a remote plasma generating tube for processing a substrate according to an embodiment of the present invention.

Referring to FIG. 3, an apparatus 100 for processing a substrate has a batch-type processing chamber 110 in which a plurality of semiconductor substrates 30 is processed.

The processing chamber 110 includes an inner chamber 114, wherein the semiconductor substrates 30 are processed, and an outer chamber 112 enclosing the inner chamber 114.

A load lock chamber 116 is disposed adjacent to, e.g., below, the processing chamber 110. A flange 118 is disposed between the processing chamber 110 and the load lock chamber 116 to connect the processing chamber 110 to the load lock chamber 116. The load lock chamber 116 may temporarily store the semiconductor substrates 30 either before or after processing in the processing chamber 110.

The processing chamber 110 and the load lock chamber 116 are separated from each other by interposing a slot valve 120 between the processing chamber 110 and the load lock chamber 116.

A boat 122 for receiving the semiconductor substrates 30 is disposed to move between the processing chamber 110 and the load lock chamber 116.

A first driving unit 124 is disposed under the load lock chamber 116 to provide a vertical driving force to the boat 122. The first driving unit 124 upwardly and downwardly transfers the boat 122. More specifically, the first driving unit 124 loads the boat 122, including the substrates 30 to be processed, into the processing chamber 110 or unloads the boat 122, including the processed substrates 30, from the processing chamber 110.

A second driving unit 126 is disposed on the outer chamber 112 to provide a rotational driving force to the boat 122. The second driving unit 126 rotates the boat 122 after the second driving unit 126 secures the boat 122 transferred into the inner chamber 114 by the first driving unit 124.

The semiconductor substrates 30 to be processed are loaded into the load lock chamber 116 through a gate valve 128 disposed on one sidewall of the load lock chamber 116. Additionally, the processed semiconductor substrates 30 are unloaded from the load lock chamber 116 through the gate valve 128.

A heat source 130, e.g., a plurality of halogen lamps, may be installed inside the outer chamber 112 to heat the inner chamber 114. Heat generated from the halogen lamps 130 is transferred to the semiconductor substrates 30 through the inner chamber 114. The outer and inner chambers 112 and 114 may include a metal or a metal alloy having high thermal conductivity. For example, the outer and inner chambers 112 and 114 may include aluminum or aluminum alloy.

In one embodiment of the present invention, a first cooling coil (not shown) may be installed around an outer surface of the inner chamber 114 to control a temperature of the semiconductor substrates 30 using a coolant passing through the first cooling coil.

In another embodiment of the present invention, a cooling gas supply line (not shown) may be provided in a space between the outer chamber 112 and the inner chamber 114. The cooling gas supply line provides a cooling gas into the space between the outer chamber 112 and the inner chamber 114.

Reaction by-products generated during processing the semiconductor substrates 30 are exhausted from the inner chamber 114 through a vacuum unit 132 connected to the inner chamber 114. The vacuum unit 132 controls an inner pressure of the inner chamber 114 and discharges the reaction by-products from the inner chamber 114. Additionally, the vacuum unit 132 exhausts particles from a remote plasma generating tube 134 connected to the inner chamber 114 when the particles are generated during a cleaning of the interior of the remote plasma generating tube 134.

The remote plasma generating tube 134 may be connected to a dispersion plate 136 disposed inside the inner chamber 114. The dispersion plate 136 has a plurality of slits for uniformly providing a remote plasma generated in the remote plasma generating tube 134 into the inner chamber 114.

A connecting member 138 connects the remote plasma generating tube 134 to the dispersion plate 136. The remote plasma generating tube 134 is also connected to a first reaction gas supply unit 140 and a cleaning gas supply unit 142.

The first reaction gas supply unit 140 provides a first reaction gas into the remote plasma generating tube 134 to generate the remote plasma in the remote plasma generating tube 134. The cleaning gas supply unit 142 provides a cleaning gas into the remote plasma generating tube 134 to clean the interior of the remote plasma generating tube 134. The first reaction gas may include hydrogen (H₂) gas or ammonia (NH₃) gas, whereas the cleaning gas may include an inactive gas, e.g., nitrogen (N₂) gas or argon (Ar) gas.

The remote plasma generating tube 134 may be connected to the first reaction gas supply unit 140 through a first mass flow controller (MFC) 140a and a first switching valve 140b. The remote plasma generating tube 134 may similarly be connected to the cleaning reaction gas supply unit 142 through a second MFC 142a and a second switching valve 142b.

A second reaction gas supply unit 144 is connected to the inner chamber 114 to provide a second reaction gas into the inner chamber 114. The second reaction gas may include a nitrogen trifluoride (NF₃) gas. The second reaction gas may be connected to the inner chamber 114 through a third MFC 144a and a third switching valve 144b.

In one embodiment of the present invention, the second reaction gas supply unit 144 may be connected to the remote plasma generating tube 134. More specifically, the second reaction gas and the first reaction gas may be provided together into the inner chamber 114 through the remote plasma generating tube 134.

An energy source 148 provides microwave energy to the remote plasma generating tube 134 through a waveguide 146 so that the first reaction gas and the cleaning gas are excited to form the remote plasma in the remote plasma generating tube 134. The waveguide 146 may be disposed substantially perpendicular to the remote plasma generating tube 134. The energy source 148 may include a microwave power source for generating microwave energy. The microwave power source may include an oscillator for generating a microwave having a frequency of about 2.5 GHz and an amplifier for amplifying the microwave generated from the oscillator.

The remote plasma generating tube 134 may include quartz (SiO₂). A second cooling coil (not shown) may be wound around an outer surface of the remote plasma generating tube 134 to control the temperature of the remote plasma generating tube 134.

In operation, when the boat 122, including the semiconductor substrates 30, is loaded into the processing chamber 110, the first reaction gas is provided from the first reaction gas supply unit 140 to the remote plasma generating tube 134. The first reaction gas enters the remote plasma generating tube 134 to form the remote plasma by the microwave energy transferred through the waveguide 146 and the remote plasma generating tube 134.

The remote plasma including the hydrogen radical is then introduced to the processing chamber 110 through the dispersion plate 136. The remote plasma is then reacted with the second reaction gas provided from the second reaction gas supply unit 144 to form a third reaction gas in the processing chamber 110.

The third reaction gas reacts with oxide in native oxide films formed on the semiconductor substrates 30 to form reaction by-products, e.g., fluorosilicates, on the semiconductor substrates 30. The reaction by-products are evaporated by the heat generated by the halogen lamps 130, and then the evaporated reaction by-products are exhausted from the processing chamber 110 through the vacuum unit 132.

The second driving unit 126 rotates the boat 122, including the semiconductor substrates 30, at a predetermined speed while the semiconductor substrates 30 are processed in the processing chamber 110 using the third reaction gas. Accordingly, the third gas may be uniformly provided onto the semiconductor substrates 30, and also the heat generated by the halogen lamps 130 may be uniformly transferred to the semiconductor substrates 30. In addition, the semiconductor substrates 30 may be uniformly cooled because the second driving unit 126 rotates the boat 122, including the semiconductor substrates 30.

After processing, the boat 122 having the processed semiconductor substrates 30 is unloaded from the processing chamber 110 to the load lock chamber 116 by the first driving unit 124.

The unloaded boat 122 having the processed semiconductor substrates 30 is transferred from the load lock chamber 116 through the gate valve 128. After another boat 122 having semiconductor substrates 30 that are to be processed is transferred into the load lock chamber 116 through the gate valve 128, the boat 122 having the semiconductor substrates 30 that are to be processed is loaded into the processing chamber 110 by the first driving unit 124.

The interior of the remote plasma generating tube 134 may be cleaned between unloading the boat 122, including the processed semiconductor substrates 30, and loading the boat 122, including the semiconductor substrates 30 to be processed. An inner surface of the remote plasma generating tube 134 may preferably be cleaned during the unloading of the boat 122 having the processed semiconductor substrates 30.

A method of cleaning an interior of a remote plasma generating tube and a method of processing a substrate using the remote plasma generating tube will be described later in detail.

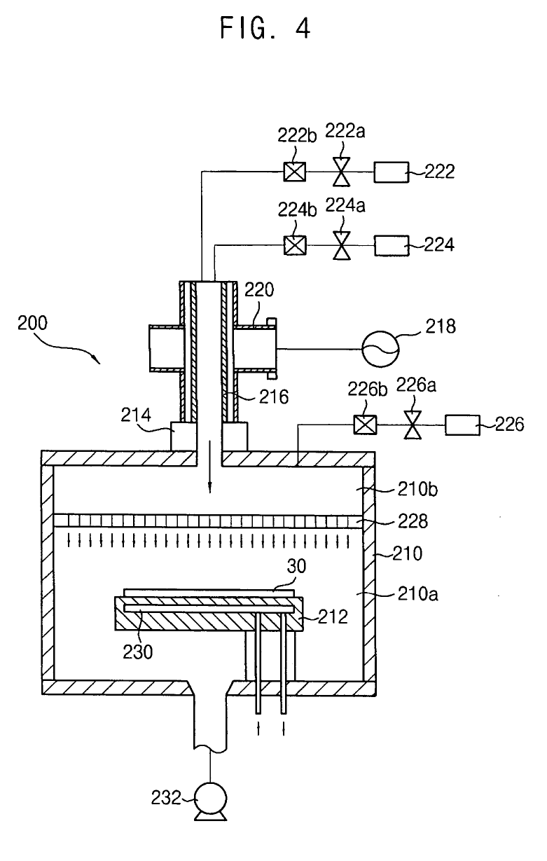

FIG. 4 illustrates a cross-sectional view of an apparatus having a remote plasma generating tube for processing a substrate in accordance with another embodiment of the present invention.

Referring to FIG. 4, an apparatus 200 for processing the substrate includes a single-type processing chamber 210 for processing a single semiconductor substrate 30.

A chuck 212 for supporting the semiconductor substrate 30 is disposed in the processing chamber 210. The processing chamber 210 is connected to a remote plasma generating tube 216 through a connecting member 214 disposed on the processing chamber 210.

An energy source 218 for providing microwave energy to the remote plasma generating tube 216 is connected to a waveguide 220, which may be disposed substantially perpendicular to the remote plasma generating tube 216.

The remote plasma generating tube 216 is connected to a cleaning gas supply unit 222 and a first reaction gas supply unit 224. The remote plasma generating tube 216 may include quartz (SiO₂) so that the microwave energy is transferred through the remote plasma generating tube 216.

A cleaning gas may be provided from the cleaning gas supply unit 222 to the remote plasma generating tube 216 through a first switching valve 222a and a first MFC 222b. A first reaction gas may be provided from the first reaction gas supply unit 224 to the remote plasma generating tube 216 through a second switching valve 224a and a second MFC 224b. The first reaction gas may include hydrogen (H₂) gas or ammonia (NH₃) gas to remove a native oxide film formed on the semiconductor substrate 30. The cleaning gas may include nitrogen (N₂) gas or argon (Ar) gas to remove particles on an interior of the remote plasma generating tube 216.

The first reaction gas in the remote plasma generating tube 216 is excited to form a remote plasma including a hydrogen radical. The remote plasma is then transferred from the remote plasma generating tube 216 to the processing chamber 210 through the connecting member 214.

A second reaction gas supply unit 226 for supplying a second reaction gas, e.g., a nitrogen trifluoride (NF₃) gas, is connected to the processing chamber 210 to provide the second reaction gas into the processing chamber 210. The second reaction gas may be introduced to the processing chamber 210 through a third switching valve 226a and a third MFC 226b.

In one embodiment of the present invention, the second reaction gas supply unit 226 may be connected to the remote plasma generating tube 216. More specifically, the first reaction gas and the second reaction gas may be provided together into the processing chamber 210 through the remote plasma generating tube 216.

An interior of the processing chamber 210 may be divided into a processing region 210a for processing the semiconductor substrate 30 and a mixing region 210b for mixing the remote plasma and the second reaction gas. A dispersion plate 228 is installed in the processing chamber 210 to divide the processing region 210a and the mixing region 210b. The dispersion plate 228 has a plurality of slits or holes to uniformly provide a third reaction gas onto the semiconductor substrate 30 supported by the chuck 212. The third reaction gas is formed in the processing chamber 210 by a reaction between the hydrogen radical contained in the remote plasma and the second reaction gas.

A heat source (not shown), e.g., a plurality of halogen lamps, may be positioned in or on one side of the processing chamber 210 to increase a temperature around the semiconductor substrate 30. In addition, the chuck 212 may be equipped with a heater (not shown) to increase the temperature around the semiconductor substrate 30. In one embodiment of the present invention, the dispersion plate 228 may be omitted from the processing chamber 210.

A cooling line 230 for providing a cooling gas or a cooling water is installed within the chuck 212 to control a temperature of the semiconductor substrate 30.

Reaction by-products are generated in the processing region 210a by reacting the third reaction gas with a native oxide film on the semiconductor substrate 30. After the reaction by-products are evaporated by increasing the temperature around the semiconductor substrate 30, the evaporated reaction by-products are discharged from the processing chamber 210 through a vacuum unit 232 connected to the processing chamber 210.

During the processing of the semiconductor substrate 30 as described above, particles formed inside the remote plasma generating tube 216 may be removed by cleaning an inner surface of the remote plasma generating tube 216 using a cleaning plasma.

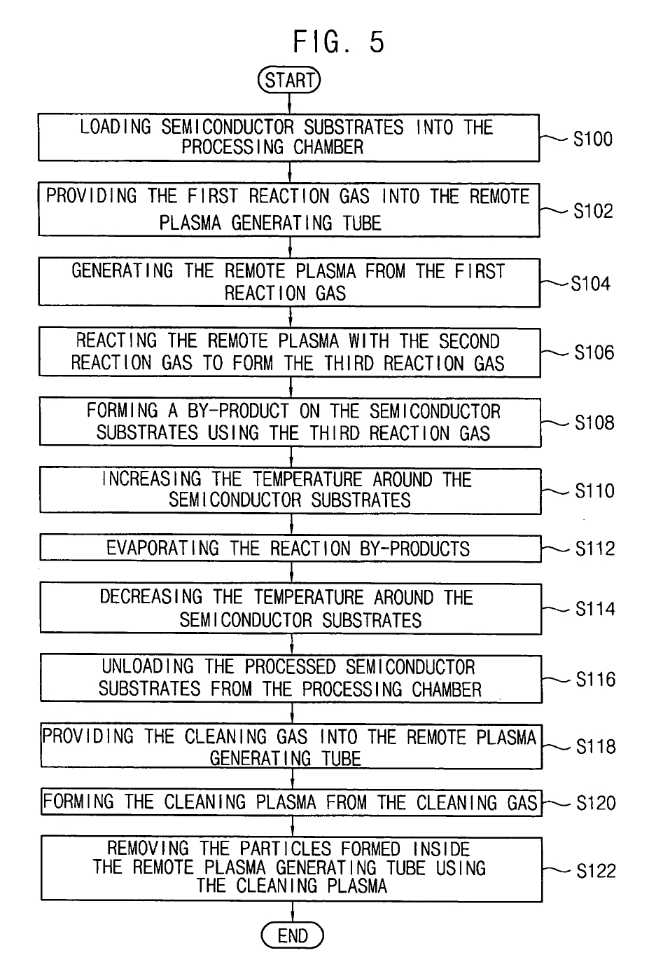

FIG. 5 is a flowchart illustrating a method of processing a substrate using the apparatus equipped with the remote plasma generating tube in FIG. 3.

Referring to FIGS. 3 and 5, in step S100, the semiconductor substrates 30 are loaded into the processing chamber 110. Predetermined layers may be formed on the semiconductor substrates 30, and films including silicon may be formed between the predetermined layers and the semiconductor substrates 30, respectively. In addition, patterns having contact holes partially exposing the semiconductor substrate 30 are formed between the predetermined layers and the semiconductor substrates 30. Each of the predetermined layers may include a native oxide film.

The semiconductor substrates 30 may be loaded into the processing chamber 110 using the boat 122. In this embodiment of the present invention, a plurality of semiconductor substrates 30 is simultaneously loaded into the processing chamber 110. Alternatively, the single-type processing chamber 210 shown in FIG. 4 may be employed for individually processing a single semiconductor substrate 30.

In step S102, the first reaction gas is provided into the remote plasma generating tube 134 connected to the processing chamber 110. The first reaction gas may include hydrogen (H₂) gas or ammonia (NH₃) gas. The first reaction gas may be introduced into the remote plasma generating tube 134 using a carrier gas. The carrier gas may include an inactive gas, e.g., nitrogen (N₂) gas or argon (Ar) gas.

In step S104, the remote plasma is generated from the first reaction gas in the remote plasma generating tube 134. Microwave energy of about 2 to about 2.8 kW may be used to excite the first reaction gas to convert the first reaction gas into the plasma phase. The microwave energy may have a frequency of about 2.45 GHz. The remote plasma generating tube 134 may include quartz (SiO₂) such that the microwave energy is transferred through the remote plasma generating tube 134.

In step S106, the remote plasma is introduced into the processing chamber 110, and the second reaction gas is also introduced into the processing chamber 110. The hydrogen radical in the remote plasma is reacted with the second reaction gas to form the third reaction gas in the processing chamber 110. The third reaction gas is used as an etching gas to remove the native oxide films formed on the semiconductor substrates 30. The remote plasma is provided into the processing chamber 110 through the connecting member 138 and the dispersion plate 136. The second reaction gas may include a fluorine-containing compound. For example, nitrogen trifluoride (NF₃) gas may be employed as the second reaction gas. The third reaction gas may include ammonium fluoride (NHₓF_{y}) formed by a reaction between the hydrogen radical and the nitrogen trifluoride (NF₃) gas. Alternatively, the second reaction gas may be provided into the processing chamber 110 via the remote plasma generating tube 134. In that case, the second reaction gas may be excited in the remote plasma generating tube 134, and then provided into the processing chamber 110. As described above, the second reaction gas may include nitrogen trifluoride gas.

In step S108, the third reaction gas is reacted with the native oxide films on the semiconductor substrates 30 to form reaction by-products, e.g., fluorosilicates. When the reaction by-products are generated, the semiconductor substrates 30 are preferably maintained at a first temperature of about 15 to about 30° C. A coolant may be used to adjust the temperature around the semiconductor substrates 30. The coolant may include liquefied nitrogen or carbon dioxide. Alternatively, cooling water may be used to control the temperature around the semiconductor substrates 30.

The time required to generate the reaction by-products using the third reaction gas may depend on the thickness of the native oxide film on the semiconductor substrates 30. Since the native oxide film generally has a thickness of several angstroms (Å), the time required to generate the reaction by-products may be in a range of about twenty (20) to about forty (40) seconds.

In step S110, the first temperature around the semiconductor substrates 30 is rapidly increased to a second temperature of about 100 to about 200° C. The first temperature around the semiconductor substrates 30 increases due to the heat transferred from the halogen lamps 130. When the temperature around the semiconductor substrates 30 increases, the reaction by-products may be partially evaporated. The temperature around the semiconductor substrates 30 may preferably increase at a rate of about 35 to about 92.5° C./minute. It is also desirable that the temperature around the semiconductor substrates 30 may be increased in less than about five (5) minutes, preferably less than about two (2) minutes. More specifically, the first temperature is increased to the second temperature within about five minutes, preferably, within about two minutes. The evaporated reaction by-products are discharged from the processing chamber 110 through the vacuum unit 132 connected to the processing chamber 110.

In step S112, the temperature around the semiconductor substrates 30 is maintained at the second temperature to evaporate the reaction by-products from the semiconductor substrates 30. The time required to evaporate the reaction by-products may be in a range of about 150 to about 210 seconds. For example, the reaction by-products may be evaporated within about 180 seconds.

In step S114, the temperature around the semiconductor substrates 30 is rapidly decreased from the second temperature to the first temperature. The temperature around the semiconductor substrates 30 decreases at a rate of about 14 to about 37° C./minute. Also, the temperature around the semiconductor substrates 30 may preferably be reduced from the second temperature to the first temperature within about five (5) minutes. A coolant may be used to decrease the temperature around the semiconductor substrates 30. The coolant may include liquefied nitrogen, carbon dioxide or a combination thereof. Alternatively, cooling water may be used to decrease the temperature around the semiconductor substrates 30.

The semiconductor substrates 30 are advantageously rotated to improve the efficiency of removing the native oxide films from the semiconductor substrate 30. The third reaction gas may be uniformly provided onto the semiconductor substrate 30 while rotating the semiconductor substrates 30. In addition, the rotation of the semiconductor substrates 30 improves the efficiency of heat transfer.

In step S116, the processed semiconductor substrates 30 are unloaded from the processing chamber 110. More specifically, the semiconductor substrates 30 are unloaded from the processing chamber 110 to the load lock chamber 116 positioned below the processing chamber 110 using the boat 122. The semiconductor substrates 30 are then transferred out of the load lock chamber 116 through the gate valve 128 connected to the load lock chamber 116. When the single-type substrate processing apparatus 200 in FIG. 4 is employed, one semiconductor substrate 30 may be unloaded from the single-type processing chamber 210 using a transfer robot (not shown) through a gate valve (not shown) installed on a sidewall of the single-type processing chamber 210.

Meanwhile, particles are formed inside the remote plasma generating tube 134 due to the remote plasma converted from the first reaction gas. Particularly, when ammonia (NH₃) gas is used as the first reaction gas, an oxynitride, e.g., silicon oxynitride (SiON), is formed on the inner surface of the remote plasma generating tube 134 due to activated species N* in the remote plasma excited by the microwave energy. When oxynitride detaches from the inner surface of the remote plasma generating tube 134, the detached oxynitride may contaminate the semiconductor substrates 30.

When hydrogen (H₂) gas is used as the first reaction gas, the remote plasma generating tube 134 may be corroded by hydrogen plasma, and particles, e.g., SiO or OH, generated due to the corrosion of the remote plasma generating tube 134 may contaminate the semiconductor substrates 30.

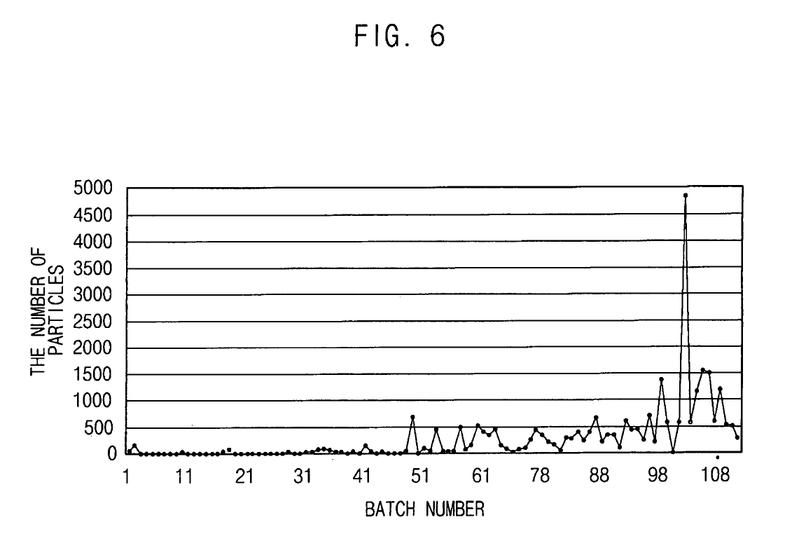

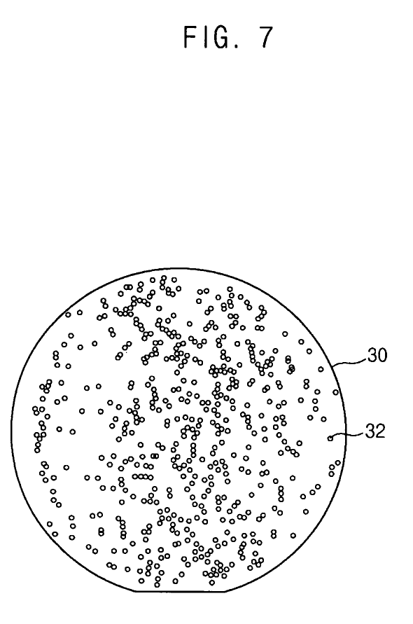

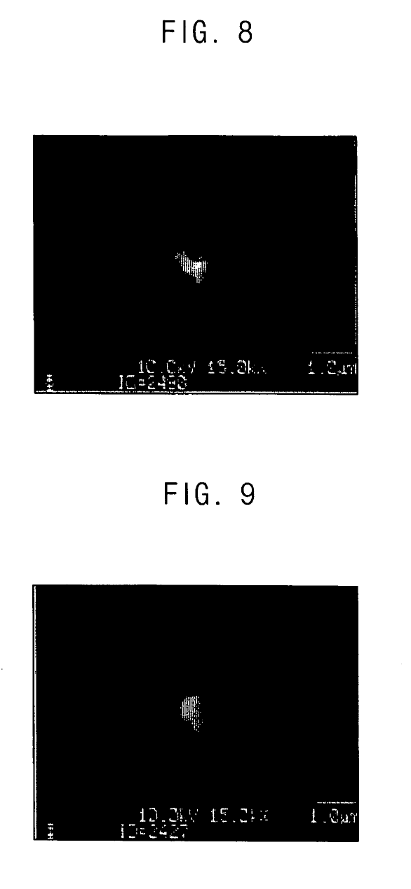

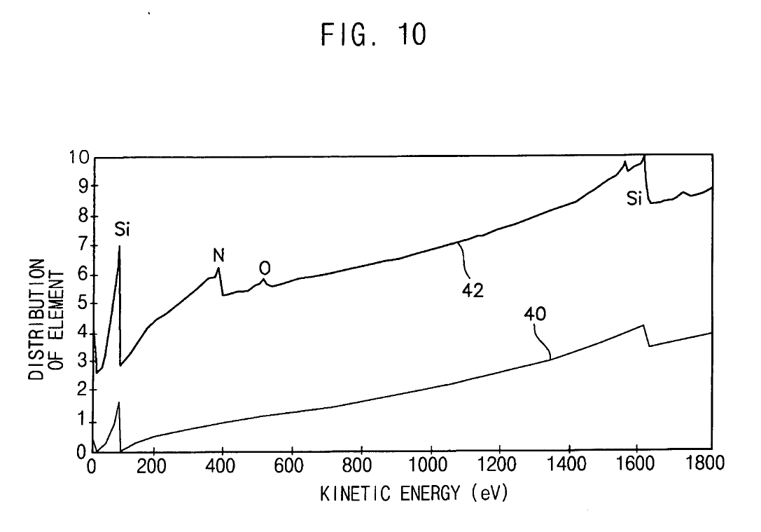

FIG. 6 is a graph showing a variance of particles on a semiconductor substrate relative to the number of batches when ammonia gas is used as the first reaction gas. FIG. 7 illustrates a plan view of particles distributed on a semiconductor substrate. FIGS. 8 and 9 are scanning electron microscope (SEM) pictures illustrating particles on semiconductor substrates. FIG. 10 is a graph showing a result of an auger electron spectroscopy (AES) analysis regarding particles on a semiconductor substrate.

By way of example, when the batch-type processing chamber 110 was used to process the semiconductor substrates 30, one hundred semiconductor substrates 30 were loaded on the boat 122. Ammonia gas was used as the first reaction gas and nitrogen trifluoride gas was used as the second reaction gas. The reaction by-products were generated on the semiconductor substrates 30 using the third reaction gas for less than about thirty (30) seconds. The temperature in the processing chamber 110 was maintained at about 20° C. After the temperature of the processing chamber 110 was rapidly increased to about 150° C., the temperature of the processing chamber 110 was maintained at about 150° C. to evaporate the reaction by-products from the semiconductor substrates 30. The temperature of the processing chamber 110 was increased for about 180 seconds at a rate of about 65° C./min. The temperature of the processing chamber 110 was maintained for about 180 seconds. The temperature of the processing chamber 110 was then decreased from about 150 to about 20° C. The temperature of the processing chamber 110 is decreased within about five (5) minutes at a rate of about 26° C./min. The processed semiconductor substrates 30 were unloaded from the processing chamber 110 to the load lock chamber 116, and then transferred from the load lock chamber 116 through the gate valve 128.

Referring to FIG. 6, the number of particles significantly increased after semiconductor substrates in a 50^{th} batch were processed, and the number of particles even more significantly increased after semiconductor substrates in a 100^{th} batch were processed.

Referring to FIGS. 7 through 10, particles 32 are distributed over an entire surface of the semiconductor substrate 30, and the particles 32 generally include silicon oxynitride (SiON). As shown in FIG. 10, when the analysis of a silicon substrate 40 is compared to an analysis of particles 42, it may be seen that the particles include nitrogen and oxygen. Thus, it may be noted that the particles are generated due to the oxynitride detached from the interior of the remote plasma generating tube 134 including quartz.

Referring back to FIGS. 3 and 5, in step S118, the cleaning gas is provided into the remote plasma generating tube 134 to clean the interior of the remote plasma generating tube 134. The inactive gas, e.g., nitrogen gas or argon gas, may be used as the cleaning gas.

In step S120, the cleaning plasma is generated from the cleaning gas introduced into the remote plasma generating tube 134 using microwave energy of about 2 to 2.8 kW. The microwave energy may have the frequency of about 2.45 GHz.

In step S122, the particles on the inner surface of the remote plasma generating tube 134 are removed using the cleaning plasma. The particles may be removed from the inner surface of the remote plasma generating tube 134 by a sputtering of the cleaning plasma. The cleaning gas is provided into the remote plasma generating tube 134 at a flow rate of about one (1) to about five (5) standard liters per minute (SLM), and the interior of the remote plasma generating tube 134 is cleaned for about thirty (30) seconds to about five (5) minutes.

The particles removed from the remote plasma generating tube 134 are discharged from the processing chamber 110 through the vacuum unit 132 connected to the processing chamber 110.

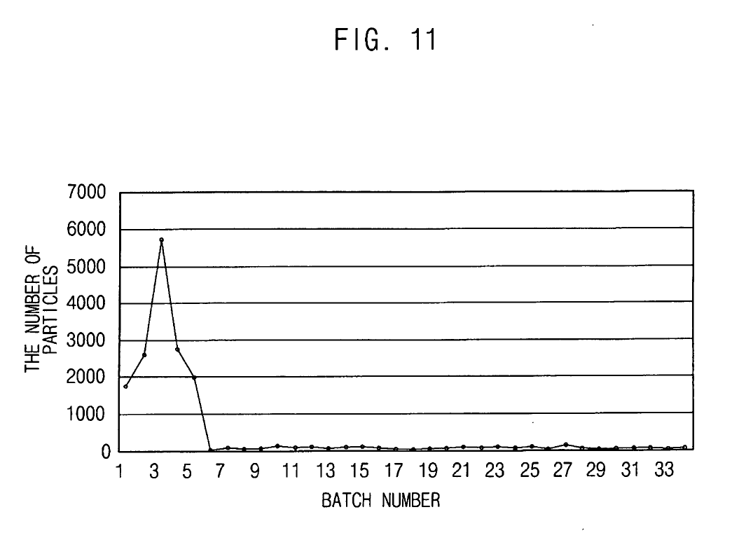

FIG. 11 is a graph showing an amount of particles generated after cleaning the remote plasma generating tube 134 using the cleaning plasma. The remote plasma generating tube 134 was cleaned after semiconductor substrates in a sixth batch are processed, and nitrogen plasma was used as the cleaning plasma.

Referring to FIG. 11, a number of particles on the semiconductor substrates 30 significantly decreased after cleaning the remote plasma generating tube 134 using the cleaning plasma. In this example, the semiconductor substrates 30 were processed using the batch-type processing chamber 110 in FIG. 3.

When the batch-type processing chamber 110 was employed, the interior of the remote plasma generating tube 134 was preferably cleaned between unloading the processed semiconductor substrates 30 out of the processing chamber 110 and loading the semiconductor substrates 30 to be processed into the processing chamber 110. More preferably, the interior of the remote plasma generating tube 134 is cleaned during the unloading of the processed semiconductor substrates 30 from the processing chamber 110. When the remote plasma generating tube 134 is cleaned together with the unloading of the processed semiconductor substrates 30, additional time for cleaning the remote plasma generating tube 134 may not be required. Therefore, the semiconductor substrates 30 may be prevented from being contaminated without decreasing throughput of the batch-type substrate processing apparatus 100.

The interior of the remote plasma generating tube 134 may be constantly cleaned before or after processing each batch of the semiconductor substrates. Alternatively, the interior of the remote plasma generating tube 134 may be cleaned after sequentially processing a predetermined number of batches.

When the single-type processing chamber 210 shown in FIG. 4 is employed, the interior of the remote plasma generating tube 216 may be cleaned after unloading the processed semiconductor substrate 30 from the processing chamber 210. Additionally, the interior of the remote plasma generating tube 216 may be constantly cleaned before or after processing each semiconductor substrate 30. Alternatively, the interior of the remote plasma generating tube 216 may be cleaned after sequentially processing a predetermined number of semiconductor substrates 30.

According to the present invention, particles generated on an interior of a remote plasma generating tube may be effectively removed using cleaning plasma. Therefore, contamination of semiconductor substrates may be prevented during etching predetermined layers formed on the semiconductor substrates. In addition, productivity of a process for manufacturing semiconductor devices may be improved.

In addition, when a batch-type substrate processing apparatus is employed, the interior of the remote plasma generating tube is cleaned between loading and unloading the semiconductor substrates into or out of the processing chamber so that the semiconductor substrates may be more efficiently processed without decreasing throughput of the batch-type substrate processing apparatus.

Exemplary embodiments of the present invention have been disclosed herein and, although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

1. A method of cleaning a remote plasma generating tube, comprising:
providing a cleaning gas into the remote plasma generating tube for generating a remote plasma, the remote plasma generating tube being connected to a processing chamber for processing a substrate using the remote plasma;
forming a cleaning plasma from the cleaning gas; and
removing particles formed inside the remote plasma generating tube using the cleaning plasma.

2. The method as claimed in claim 1, wherein forming the cleaning plasma comprises using microwave energy.

3. The method as claimed in claim 1, wherein the cleaning gas comprises an inactive gas.

4. The method as claimed in claim 3, wherein the cleaning gas comprises any one selected from the group consisting of nitrogen (N₂) gas and argon (Ar) gas.

5. The method as claimed in claim 1, wherein the remote plasma generating tube comprises quartz (SiO₂).

6. The method as claimed in claim 5, wherein the particles comprise reaction by-products generated by a reaction between the quartz and a reaction gas for processing the substrate.

7. The method as claimed in claim 6, wherein the reaction gas comprises any one selected from the group consisting of hydrogen (H₂) and ammonia (NH₃).

8. A method of processing a substrate using a remote plasma generating tube, comprising:
forming a remote plasma from a first reaction gas using the remote plasma generating tube connected to a processing chamber for processing a substrate in the processing chamber;
introducing the remote plasma into the processing chamber to process the substrate;
providing a cleaning gas into the remote plasma generating tube;
forming a cleaning plasma from the cleaning gas; and
removing particles formed inside the remote plasma generating tube using the cleaning plasma.

9. The method as claimed in claim 8, wherein the first reaction gas comprises any one selected from the group consisting of hydrogen and ammonia.

10. The method as claimed in claim 9, wherein the remote plasma generating tube comprises quartz.

11. The method as claimed in claim 10, wherein the particles comprise reaction by-products generated by a reaction between the first reaction gas and the quartz.

12. The method as claimed in claim 11, wherein the particles comprise silicon oxynitride (SiON).

13. The method as claimed in claim 8, wherein the remote plasma comprises a hydrogen radical.

14. The method as claimed in claim 13, wherein introducing the remote plasma into the processing chamber to process the substrate further comprises etching a layer formed on the substrate.

15. The method as claimed in claim 14, wherein the layer formed on the substrate comprises a native oxide film.

16. The method as claimed in claim 15, wherein etching the layer further comprises:
providing a second reaction gas into the processing chamber to form an etching gas by a reaction between the hydrogen radical and the second reaction gas;
reacting the etching gas with the native oxide film to form reaction by-products on the substrate; and
removing the reaction by-products.

17. The method as claimed in claim 16, wherein reacting the etching gas with the native oxide film is performed at a temperature of about 15 to about 30° C.

18. The method as claimed in claim 16, wherein removing the reaction by-products further comprises:
evaporating the reaction by-products by increasing a temperature around the substrate to a range of about 100 to about 200° C.; and
discharging the evaporated reaction by-products.

19. The method as claimed in claim 16, wherein the second reaction gas comprises nitrogen trifluoride (NF₃).

20. The method as claimed in claim 8, wherein introducing the remote plasma into the processing chamber comprises processing a plurality of substrates.

21. The method as claimed in claim 8, wherein forming the remote plasma and forming the cleaning plasma comprise using microwave energy.

22. The method as claimed in claim 8, wherein the cleaning gas comprises an inactive gas.

23. The method as claimed in claim 8, wherein providing the cleaning gas comprises providing the cleaning gas at a flow rate of about one (1) to about five (5) standard liters per minute (SLM).

24. The method as claimed in claim 8, wherein providing the cleaning gas, forming the cleaning plasma and removing the particles are performed for about thirty (30) seconds to about five (5) minutes.

25. The method as claimed in claim 8, further comprising:
loading the substrate to be processed into the processing chamber; and
unloading a processed substrate from the processing chamber.

26. The method as claimed in claim 25, wherein providing the cleaning gas, forming the cleaning plasma and removing the particles are performed while unloading the processed substrate from the processing chamber.

27. The method as claimed in claim 25, wherein providing the cleaning gas, forming the cleaning plasma and removing the particles are performed between unloading the processed substrate from the processing chamber and loading a substrate to be processed into the processing chamber.

28. The method as claimed in claim 8, wherein forming the remote plasma and introducing the remote plasma are repeatedly performed after removing the particles.

29. The method as claimed in claim 8, wherein providing the cleaning gas, forming the cleaning plasma, and removing the particles are performed before forming the remote plasma and introducing the remote plasma, the method further comprising:
loading the substrate into the processing chamber, after removing the particles, and then forming the remote plasma by providing the first reaction gas into the remote plasma generating tube.

30. The method as claimed in claim 29, wherein loading the substrate into the processing chamber comprises loading a plurality of substrates into the processing chamber and the remote plasma is introduced into the processing chamber to process the plurality of the substrates.

31. The method as claimed in claim 30, further comprising unloading a processed substrate from the processing chamber,
wherein providing the cleaning gas into the remote plasma generating tube, forming the cleaning plasma from the cleaning gas and removing the particles formed inside the remote plasma generating tube are performed while unloading the processed substrate from the processing chamber.

32. The method as claimed in claim 30, further comprising unloading a plurality of processed substrates from the processing chamber,
wherein providing the cleaning gas into the remote plasma generating tube, forming the cleaning plasma from the cleaning gas and removing the particles formed inside the remote plasma generating tube are performed between unloading the processed substrates from the processing chamber and loading substrates to be processed into the processing chamber.

33. The method as claimed in claim 29, wherein forming the cleaning plasma and forming the remote plasma comprise using microwave energy transferred through the remote plasma generating tube.

34. The method as claimed in claim 29, wherein loading the substrate into the processing chamber comprises:
using a boat, in which the substrate is disposed; and
moving the boat into the processing chamber.

35. The method as claimed in claim 8, before providing the cleaning gas into the remote plasma generating tube, further comprising:
introducing a second reaction gas into the processing chamber while introducing the remote plasma;
forming a third reaction gas by reacting the remote plasma with the second reaction gas;
forming reaction by-products by reacting the third reaction gas with a layer formed on the substrate loaded in the processing chamber;
evaporating the reaction by-products; and
discharging the evaporated reaction by-products from the processing chamber.

36. The method as claimed in claim 35, wherein the layer comprises a native oxide film.

37. The method as claimed in claim 35, wherein the remote plasma comprises a hydrogen radical.

38. The method as claimed in claim 35, wherein the second reaction gas comprises nitrogen trifluoride.

39. The method as claimed in claim 35, wherein evaporating the reaction by-products comprises evaporating the reaction by-products at a temperature of about 100 to about 200° C.

40. The method as claimed in claim 35, wherein the remote plasma generating tube comprises quartz, and the first reaction gas comprises any one selected from the group consisting of hydrogen and ammonia.

41. The method as claimed in claim 35, wherein the cleaning gas comprises any one selected from the group consisting of nitrogen and argon.

42. An apparatus for processing a substrate using a remote plasma generating tube, comprising:
a processing chamber for receiving a substrate to be processed;
a remote plasma generating tube connected to the processing chamber;
an energy source for applying energy to the remote plasma generating tube to excite a gas provided into the remote plasma generating tube to a plasma phase;
a reaction gas supply unit for supplying the remote plasma generating tube with a reaction gas to form a remote plasma for processing the substrate; and
a cleaning gas supply unit for supplying the remote plasma generating tube with a cleaning gas to form a cleaning plasma for removing particles formed inside the remote plasma generating tube.

43. The apparatus as claimed in claim 42, wherein the energy source comprises a microwave power source.

44. The apparatus as claimed in claim 42, further comprising a second reaction gas supply unit for supplying a second reaction gas into the processing chamber.

45. The apparatus as claimed in claim 42, further comprising a dispersion plate having a plurality of slits to uniformly provide the reaction gas into the processing chamber.

46. The apparatus as claimed in claim 42, further comprising a load lock chamber disposed adjacent to the processing chamber, wherein the load lock chamber temporarily stores a processed substrate and the substrate to be processed.

47. The apparatus as claimed in claim 46, further comprising a boat for receiving a plurality of substrates, wherein the boat is operable to move between the processing chamber and the load lock chamber.

48. The apparatus as claimed in claim 42, further comprising a heater for heating the substrate.

49. The apparatus as claimed in claim 42, further comprising a chuck disposed in the processing chamber to support the substrate.

50. The apparatus as claimed in claim 42, further comprising a vacuum unit connected to the processing chamber to discharge reaction by-products generated during the processing of the substrate and particles removed from the remote plasma generating tube.
